(19) United States
(12) Patent Application Publication
(10) Pub. No.: US 2026/0336203 A1
(43) Pub. Date: Oct. 29, 2026

(54) HIGH-YIELD THREE-DIMENSIONAL PRINTING FOR MICROFLUIDICS

(71) Applicant: Brigham Young University, Provo, UT (US)

(72) Inventors: Gregory Packer Nordin, Lindon, UT (US); Dallin Scott Miner, Orem, UT (US)

(21) Appl. No.: 19/659,527

(22) Filed: Apr. 27, 2026

Related U.S. Application Data
(60) Provisional application No. 63/794,967, filed on Apr. 25, 2025.

(51) Int. Cl. B29C 64/129; B29C 64/314; B29C 64/364; B29C 64/393; B29L 31/00; B33Y 10/00; B33Y 30/00; B33Y 40/10; B33Y 50/02; B33Y 70/00

(52) U.S. Cl. CPC B29C 64/129; B29C 64/314; B29C 64/364; B29C 64/393; B33Y 10/00; B33Y 40/10; B33Y 50/02; B33Y 70/00; B29L 2031/756; B33Y 30/00

(57) ABSTRACT

High-yield 3D printing of microfluidic devices is achieved through vacuum-enhanced printing, spatially resolved optical correction, and specialized resin chemistry. Dissolved gases are removed from the resin, preventing bubble entrapment and ensuring uniform polymerization. Grayscale correction eliminates non-uniform illumination, allowing for high-resolution features across the print area. The resin chemistry balances flexibility, strength, and print fidelity, enabling the creation of complex microfluidic devices with clean, interconnected negative features. These techniques can be used in various printing environments, including atmospheric pressure, to produce high-quality microfluidic devices with improved yield and consistency.

### CROSS REFERENCE TO RELATED APPLICATION

This application claims the benefit of U.S. Provisional Application No. 63/794,967, filed on Apr. 25, 2025, which is hereby incorporated by reference in its entirety.

### STATEMENT REGARDING FEDERALLY SPONSORED RESEARCH OR DEVELOPMENT

This invention was made with government support under R15GM123405-03 and R15GM132858-02 awarded by the National Institutes of Health (NIH) and grant number 2245494 awarded by the National Science Foundation (NSF). The government has certain rights in the invention.

### FIELD OF THE INVENTION

The present invention relates to microfluidic device fabrication.

### BACKGROUND

A microfluidic device is a structured substrate (i.e., chip) that manipulates tiny amounts of fluids through tiny channels. These devices can be used to automatically mix and react chemicals and can function like a “lab on a chip”. The size and complexity of these devices can help reduce the volume of expensive and rare liquids, as well as increase the speed of a reaction by running many experiments in parallel. A microfluidic device may include interconnected negative features (e.g., channels, pores, chambers) that can route, control, and filter fluids. These negative features can be very small. For example, a microfluidic device can include channels, which are 18 micrometers (μm) high by 20 μm wide. These channels may serve as the “veins” of the chip to transport reagents, samples, and waste between different functional zones on the chip. A membrane may be placed between two channels and moved (e.g., via a pneumatic control line) into one of two positions to control flow between the channels. In some cases, a porous membrane may be placed between vertically stacked channels, which can filter the fluid. The pores can be less than 10 μm in diameter, which can be arranged in a uniform grid to provide a 50/50 fill factor over a surface area of the membrane. Fabricating microfluidic devices with negative features of this scale have traditionally required systems and methods that emphasize precision at the expense of complexity and speed. Accordingly, faster and lower-complexity manufacturing processes may be desired, but faster and lower-complexity manufacturing processes may suffer from lower yields and less consistent performance.

### SUMMARY

Additive manufacturing processes, such as three-dimensional (i.e., 3D) printing, are faster and less complex than photolithography-based manufacturing processes but can struggle to maintain uniform precision across large print areas or prevent structural defects during fabrication. The present disclosure describes 3D printing fabrication methods and systems to improve the scalability and density of microfluidic devices. In particular, the present disclosure provides vacuum-enhanced printing methods to eliminate bubble entrapment, spatially resolved optical correction methods to ensure uniform polymerization, and a 3D printing system integrating these capabilities.

In some aspects, the techniques described herein relate to a method for 3D printing, the method including: stirring a resin contained within a resin tray within a first vacuum chamber; depressurizing the first vacuum chamber to remove dissolved gases in the resin, thereby creating a degassed resin; transferring the resin tray containing the degassed resin from the first vacuum chamber to a second vacuum chamber of a 3D printer; depressurizing the second vacuum chamber to maintain a vacuum environment around the resin; moving a projector of the 3D printer and a print surface of the 3D printer so that a layer of the degassed resin is in a print area of the projector; and projecting an image into the print area using the projector to polymerize the layer of the degassed resin according to the image.

In some aspects, the techniques described herein relate to a method for 3D printing, the method including: projecting a first image into a print area using a projector of a 3D printer; moving the projector to measure a first set of irradiances at spatially distinct points using an optical detector positioned in the print area of the projector; analyzing the first set of irradiances to determine a first variation of irradiance across the print area corresponding to the first image; adjusting grayscale values of the first image based on the first variation to generate a second image, the second image being a version of the first image with adjusted grayscale values; moving the projector and a print surface of the 3D printer so that a layer of degassed resin is in the print area of the projector; and projecting the second image into the print area using the projector to polymerize the layer of the degassed resin according to the second image.

In some aspects, the techniques described herein relate to a system for 3D printing, the system including: a degassing stage including: a first vacuum chamber configured to receive a resin tray containing a resin and to degas the resin to remove dissolved gases in the resin, thereby creating a degassed resin; a printing stage including: a second vacuum chamber configured to receive the resin tray containing the degassed resin and to prevent a return of the dissolved gases during a printing process; a motion stage configured to move a projection system configured to project images; and an optical detector configured to measure irradiance at a point; and a controller configured to: control the motion stage to scan the projection system so that the optical detector receives spatial samples of an image projected by the projection system; determine grayscale adjustments based on the spatial samples; and apply the grayscale adjustments to the projection system to remove non-uniformities in subsequent images projected by the projection system.

In some aspects, the techniques described herein relate to a method for 3D printing, the method including: depressurizing a vacuum chamber to remove dissolved gases in a resin contained within a resin tray, thereby creating a degassed resin, the degassed resin remaining free of bubbles for a time period while at atmospheric pressure; transferring the resin tray containing the degassed resin from the vacuum chamber to a 3D printer; and projecting an image into a print area of the 3D printer at the atmospheric pressure to polymerize the degassed resin, wherein the step of projecting the image is constrained to be completed within the time period before the atmospheric pressure dissolves gases into the resin.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIGS. 1A-1D are visual representations of steps in a DLP 3D printing process according to a possible implementation of the present disclosure.

FIG. 2 is a perspective view of a microfluidic device according to a possible implementation of the present disclosure.

FIG. 3 is a flowchart of a method for 3D printing a microfluidic device according to a first possible implementation of the present disclosure.

FIG. 4 is a flowchart of a method for 3D printing a microfluidic device according to a second possible implementation of the present disclosure.

FIG. 5 is a schematic block diagram of a system for 3D printing a microfluidic device according to a possible implementation of the present disclosure.

FIG. 6 is a flowchart for a method for 3D printing a microfluidic device according to a third possible implementation of the present disclosure.

FIG. 7 visually illustrates a grayscale adjustment according to a possible implementation of the present disclosure.

FIG. 8 illustrates the chemical diagrams of resin components according to a possible implementation of the present disclosure.

The components in the drawings are not necessarily to scale relative to each other. Like reference numerals designate corresponding parts throughout the several views.

### DETAILED DESCRIPTION

Traditional microfabrication methods for microfluidic devices can be expensive, labor-intensive, and slow due to their use of soft lithography, wet/dry etching, and/or micro-milling. 3D printing may cut the cost and time of these traditional microfabrication methods. What is more, 3D printing liberates microfluidic device design from planar constraints, allowing engineers to utilize all three dimensions (x, y, and z) for intricate component geometry, complex channel routing, and precise placement. Further, 3D printing can prototype microfluidic devices in the exact same robust thermoplastics and resins used in mass manufacturing techniques. Accordingly, 3D printing systems/methods may be highly desirable for both prototyping and commercial manufacture of microfluidic devices.

Digital light processing (i.e., DLP) 3D printing operates by using a digital projector to cure an entire two-dimensional area of a resin layer in one exposure, making it a remarkably efficient method for high-resolution fabrication. Despite its advantages, existing DLP 3D printing for microfluidic device fabrication faces several technical problems. First, non-uniform illumination across the print area (e.g., the edges of the print area receiving less irradiance than the center) can require features to be placed in a particular portion of the print area (e.g., the center) for the best results. Second, small bubbles, generated in the resin during the print process, can be embedded in the final microfluidic device. These bubbles tend to cluster in the center of the print area or in regions with high feature density, necessitating manual adjustment of exposure settings in different areas of the print.

To address (at least) these technical problems, a set of methods is described which, when taken together, result in the high-yield printing of high-resolution negative features across the full print area of a DLP 3D printer. A technical effect of the disclosed method is an improved yield of printed devices with conforming negative features and porous membranes for microfluidics.

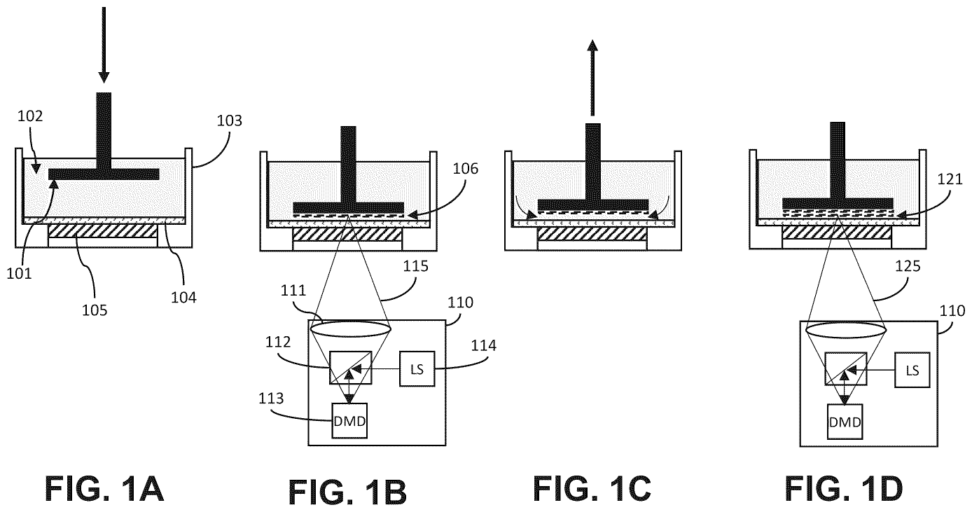

FIGS. 1A-1D are visual representations of steps in a DLP 3D printing process according to a possible implementation of the present disclosure. FIG. 1A illustrates the print setup step of the DLP 3D printing process. As shown, a resin tray 103 is configured to receive and contain a volume of liquid resin. The resin tray 103 may be structured as a circular reservoir comprising a window 105 that forms its bottom surface. The window 105 is generally a glass substrate with a minimized thickness to allow projected optical images to pass through into the print area without causing optical diffusion or distortion.

Covering the inner bottom surface of the resin tray 103 is a film 104, which may be adhered directly over the window 105. The film 104 may be an optically clear, fluorinated ethylene propylene (FEP) or Teflon film. The primary purpose of the film 104 is to provide a smooth, non-stick release surface. This non-stick surface prevents the polymerized resin from adhering to the rigid glass of the window 105, ensuring that the delicate polymerized layers do not tear apart during subsequent vertical lift and separation steps.

Prior to the start of the printing process, the (liquid) resin 102 is dispensed into the resin tray 103, filling the reservoir above the film 104 to form a resin bath. According to certain embodiments of the present disclosure, the resin 102 may be a degassed resin (e.g., a resin comprising a diacrylate monomer, a photoinitiator, a tetraacrylate crosslinker, and a TEMPOL polymerization inhibitor) that was previously stirred and depressurized in a first vacuum chamber to remove dissolved atmospheric gases.

As shown in FIG. 1B, to initiate printing, a build platform of the 3D printer is lowered into the resin 102 to provide a print surface 101 for the device. In other words, the bottom surface of the build platform is configured as the print surface 101. In some embodiments, the print surface 101 may comprise a removable glass slide adhered to the bottom of the build platform. The print surface 101 is lowered until it is suspended just above the film 104 (e.g., at a layer thickness of approximately 10 micrometers). By moving the build platform and the print surface 101 into this position, a uniform layer of the resin 102 (i.e., the degassed resin) is mechanically trapped between the print surface 101 and the film 104. This positions the layer of the resin 102 directly within a print area of a projector 110, queuing up the layer of the degassed resin to be selectively polymerized according to an image projected by the projector 110. The print area of the projector is the field of view of the projector in a focal plane of the projector. In other words, images formed in the print area are in focus.

After the layer is created in the print area, the projector 110 is configured to project an image into the print area to polymerize the layer of the resin 102. As illustrated, the projector 110 includes a light source 114 (LS), a beam splitter 112, a digital mirror device 113 (DMD), and a lens 111. The light source 114 emits light toward the beam splitter 112, which directs the light to the digital mirror device 113. The digital mirror device 113 provides spatial light modulation to generate a first image 115. This first image 115 is then projected through the lens 111, passing up through the window 105 and the film 104 of the resin tray 103, and into the print area where it forms a real image.

During the exposure of the layer of resin 102, the first image 115 projected by the projector 110 comprises light areas and dark areas. The light areas of the first image 115 expose corresponding regions of the resin 102 to sufficient optical irradiance to crosslink and polymerize the resin, thereby forming a hardened first layer 106 adhered to the print surface 101. Conversely, the dark areas of the first image 115 leave corresponding regions of the resin 102 unexposed, preventing polymerization in those regions. These unexposed regions define negative features within the first layer 106 that will subsequently be flushed of unpolymerized liquid resin to form the interconnected microfluidic structures of the device.

The exposure period during the 3D printing process controls the optical dose delivered to the resin, which directly determines the degree of polymerization within each printed layer. Generally, shorter exposure periods result in less polymerization, yielding a softer material (e.g., lower Shore A hardness) and reduced structural integrity. Conversely, extending the exposure period increases the polymer density, producing a harder and more robust polymerized material. However, longer exposure periods traditionally increase the risk of stray light causing unwanted polymerization in regions intended to be voids, which can clog the negative features of the microfluidic device. In the present disclosure, the addition of a polymerization inhibitor, such as TEMPOL, and a tetraacrylate additive, such as DTMPTA, modifies this relationship. The inhibitor scavenges free radicals, preventing unwanted polymerization in the dark regions and thereby increasing an illumination threshold for initiating polymerization. Simultaneously, the tetraacrylate additive provides four reaction sites per molecule, which restores high polymer density and material strength in the exposed regions. Because of these chemical adjustments, the resin can tolerate substantially higher exposure doses and longer exposure periods. This allows the system to achieve the necessary material hardness and structural stability without over-polymerizing the unexposed regions, ultimately preventing the negative features from clogging during the printing process.

A separation step of the 3D printing process is illustrated in FIG. 1C. Following the polymerization of the first layer 106, a translation stage pulls the build platform and the print surface 101 up and away from the film 104. This upward movement lifts the hardened first layer 106 off the non-stick surface of the film 104. During this separation step, the build platform is raised by a distance of half a millimeter to one millimeter. This vertical movement detaches the first layer 106 and draws fresh liquid resin 102 from the surrounding liquid bath into the space beneath the first layer 106 to prepare for the next exposure.

This upward movement of the build platform creates a localized low-pressure region between the first layer 106 and the film 104. Traditionally, this sudden low-pressure event draws dissolved atmospheric gases out of the liquid resin 102, causing them to evolve into small gas bubbles. As the build platform is subsequently lowered to position the next layer, these bubbles become trapped. Because the mechanical forces during the lowering step push the resin 102 outward from the center, these bubbles tend to accumulate directly in the center of the print region or attach themselves to sharp corners of the printed structures. If a bubble is trapped in the print area during a subsequent exposure, it prevents the resin from polymerizing in that specific location, causing structural defects or unwanted voids that alter the unexposed regions defining the negative features. This low-pressure event is the basis for using a degassing process prior to printing. The degassing process includes depressurizing a vacuum chamber to remove dissolved gases from the resin 102 prior to printing. The resulting degassed resin can withstand this low-pressure separation step without forming the defect-causing bubbles.

Turning to FIG. 1D, a subsequent layer formation step of the 3D printing process is illustrated. Following the separation step, the build platform and the print surface 101 are lowered again to queue up another uniform layer of the liquid resin 102 between the hardened first layer 106 and the film 104. The projector 110 then projects a second image 125 into the print area to polymerize the degassed resin according to the second image 125, thereby forming a hardened second layer 121. As shown in the illustration, the second image 125 may have a different pattern of light areas and dark areas, leaving specific regions unexposed to define three-dimensional negative features within the bulk material.

The steps of repeatedly moving the print surface 101 and projecting images are performed to sequentially polymerize multiple layers of the degassed resin to form a microfluidic device 200. Because the resin 102 was previously degassed in the vacuum chamber, the sequential printing process can be completed without dissolved gases evolving into gas bubbles during the separation steps, thereby preventing bubble entrapment that would otherwise cause structural defects in the negative features.

Once the multiple consecutive prints are completed and the polymerized layers forming the microfluidic device 200 are detached from the 3D printer, the unpolymerized degassed resin remains trapped within the unexposed regions. To finish forming the microfluidic device 200, the unpolymerized degassed resin may be flushed from the regions corresponding to the dark regions of the projected images. Forming the microfluidic device 200 includes applying pressurized air to force the unpolymerized liquid resin out of the unexposed regions defining the negative features. Next, the unexposed regions defining the negative features are flushed with isopropyl alcohol to clear any remaining residue. Finally, the microfluidic device 200 is post-cured with a 435 nm LED curing station to achieve its final material strength. This flushing and curing process yields a microfluidic device 200 having clean, interconnected negative features, such as channels and valve chambers, ready for fluidic operation.

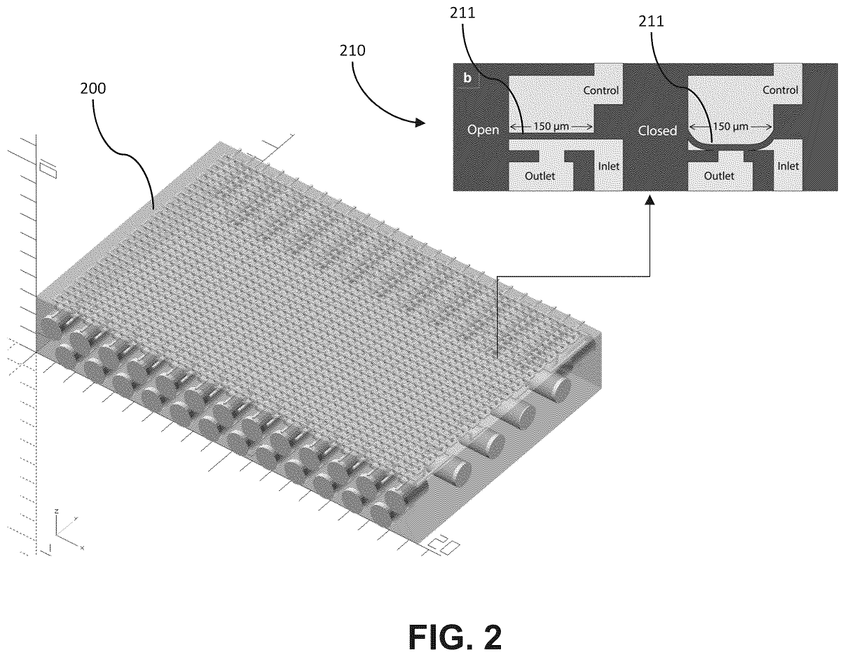

FIG. 2 is a perspective view of an example microfluidic device according to a possible implementation of the present disclosure. The microfluidic device 200 is formed from a plurality of sequentially polymerized layers of the degassed resin using the 3D printing methods described herein. The microfluidic device 200 includes interconnected negative features that are formed by applying pressurized air to force unpolymerized liquid resin out of the unexposed regions, followed by flushing the unexposed regions with isopropyl alcohol. As illustrated, the microfluidic device 200 may comprise a complex, high-density architecture, such as an array of 1,600 or more interconnected valves distributed across the printed area.

FIG. 2 further illustrates a valve cross section 210 to detail the internal negative features of the microfluidic device 200. The valve cross section 210 includes a pneumatic control chamber and a fluidic chamber separated by a flexible membrane 211. The membrane 211 is a polymerized structure formed directly within the bulk material of the microfluidic device 200 during the layer-by-layer printing process. In operation, applying pressure to the pneumatic control chamber deflects the membrane 211 into the fluidic chamber. This deflection allows the membrane 211 to selectively open or close a fluid pathway, such as by sealing an inlet channel within the fluidic chamber to control fluid flow. In some embodiments, these valves may be highly miniaturized, having a diameter of approximately 150 micrometers.

Material flexibility and structural strength of the membrane 211 can be balanced to function properly. This balance can be achieved by the chemical composition of the degassed resin, which may include a diacrylate monomer, a photoinitiator, a TEMPOL polymerization inhibitor, and a tetraacrylate crosslinker. The addition of the tetraacrylate crosslinker, such as DTMPTA, restores structural stability to the material that might otherwise be compromised by the inhibitor. By replacing a portion of the monomer concentration (e.g., between approximately 1% and 10%) with the tetraacrylate crosslinker, the polymerized membrane 211 remains flexible enough to repeatedly actuate without breaking, while maintaining sufficient strength to withstand the mechanical forces of the 3D printing process.

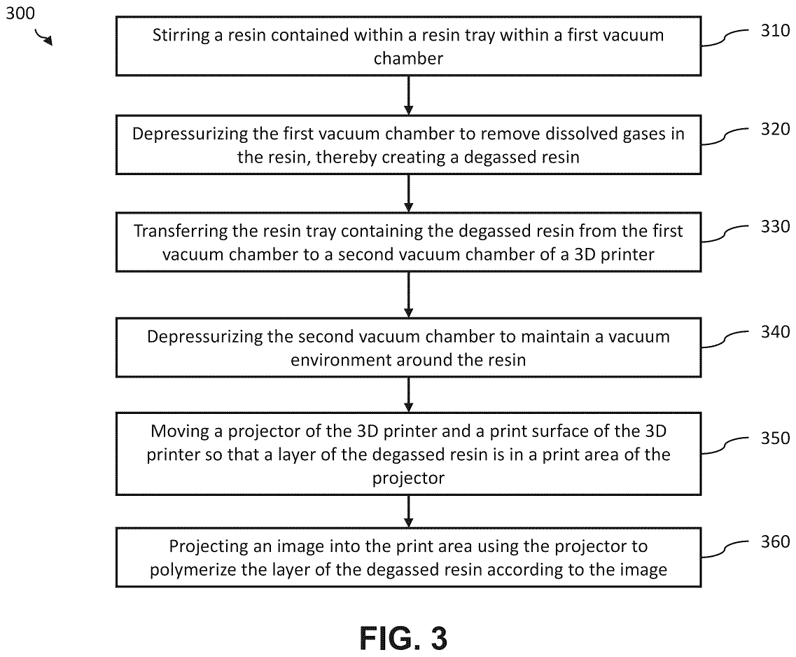

FIG. 3 is a flowchart of a method for 3D printing a microfluidic device according to a first possible implementation of the present disclosure. The method 300 begins at step 310 by stirring a resin contained within a resin tray within a first vacuum chamber. To agitate the resin without causing defects, the stirring may be performed using a magnetic ring stir bar suspended within the liquid resin just above the bottom of the resin tray. Suspending the stir bar prevents physical contact with and potential scratching of the non-stick film covering the bottom inner surface of the resin tray.

At step 320, the method includes depressurizing the first vacuum chamber to remove dissolved gases in the resin, thereby creating a degassed resin. The first vacuum chamber may be depressurized to approximately 35 mTorr for a period of time to rapidly pull dissolved atmospheric gases, such as oxygen and nitrogen, out of the resin. Because dissolved oxygen naturally acts as a polymerization inhibitor that scavenges free radicals, its removal may require a compensatory resin chemistry to prevent stray light from over-polymerizing the unexposed regions. Accordingly, the resin formulation includes a base monomer, a photoinitiator, a polymerization inhibitor such as TEMPOL at a concentration of approximately 200 ppm to replace the inhibiting function of the lost oxygen, and a tetraacrylate crosslinker such as DTMPTA to restore structural strength and eliminate material chalkiness caused by the inhibitor.

At step 330, the method 300 includes transferring the resin tray containing the degassed resin from the first vacuum chamber to a second vacuum chamber of a 3D printer. The second vacuum chamber can include a bell jar that encloses the print area, the resin tray, and the build platform.

At step 340, the method 300 includes depressurizing the second vacuum chamber to maintain a vacuum environment around the resin. For example, the bell jar may be depressurized to hold the print area at a vacuum of approximately 200 mTorr. Maintaining this vacuum environment during the printing process ensures that atmospheric gases cannot dissolve back into the degassed resin, which prevents the nucleation and entrapment of bubbles during the low-pressure events caused by the vertical separation movements of the build platform.

At step 350, the method 300 includes moving a projector of the 3D printer and a print surface of the 3D printer so that a layer of the degassed resin is in a print area of the projector.

At step 360, the method 300 includes projecting an image into the print area using the projector to polymerize the layer of the degassed resin according to the image. To ensure uniform polymerization across the entire print area, the projected image utilizes an optical grayscale correction. This correction is achieved by moving the projector to measure a set of irradiances at spatially distinct points using an optical detector, analyzing those measurements to determine the variation of irradiance across the print area, and multiplying the projected image by an inverted grayscale map to digitally dim the brightest areas.

The steps of moving the print surface and projecting grayscale-corrected images are repeated to sequentially polymerize multiple layers of the degassed resin to form the complete microfluidic device under a vacuum. Once the printing process is finished, the microfluidic device is removed from the 3D printer so that the unexposed regions can be cleared. Clearing can include applying pressurized air to force the unpolymerized degassed resin out of the unexposed regions defining the negative features. Next, the unexposed regions are flushed with isopropyl alcohol to remove any residual liquid. Finally, the interconnected negative features and the bulk material of the microfluidic device can be post-cured using a 435 nm LED curing station.

In addition to structural defects caused by gas bubbles, printing artifacts can also arise from non-uniform illumination, where some areas of the print area are inherently dimmer than others due to the optical system. For example, the edges of the print area tend to receive less irradiance while the center receives more, which can lead to uneven polymerization and limit where high-resolution negative features can be successfully placed. To overcome this, a spatially resolved grayscale correction method can be utilized. This method can be seamlessly coupled with the vacuum degassing process and the specialized resin chemistry described previously to ensure high-yield fabrication across the entire print area.

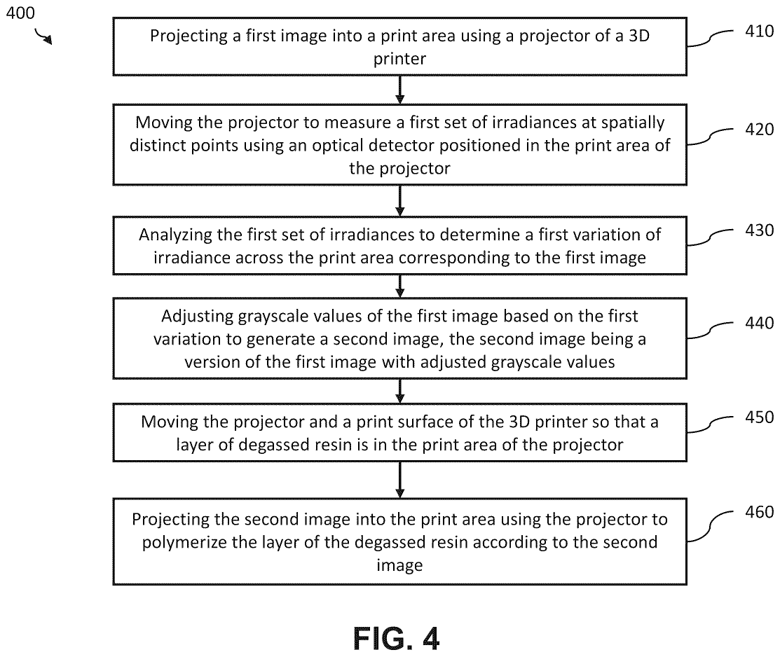

FIG. 4 is a flowchart of a method for 3D printing a microfluidic device according to a second possible implementation of the present disclosure. At step 410, the method 400 includes projecting a first image into a print area using a projector of a 3D printer.

At step 420, the method 400 includes moving the projector to measure a first set of irradiances at spatially distinct points using an optical detector positioned in the print area of the projector. To achieve this, a motion stage can translate the projection system to scan multiple points across the projected image to measure the irradiance values, such as by using an optical fiber routed to a photodiode.

At step 430, the method 400 includes analyzing the first set of irradiances to determine a first variation of irradiance across the print area corresponding to the first image. This establishes a spatial map identifying the brightest and dimmest regions of the projected image.

At step 440, the method 400 includes adjusting grayscale values of the first image based on the first variation to generate a second image, the second image being a version of the first image with adjusted grayscale values. This adjustment may involve applying an inverted map to digitally dim the bright areas of the projected image. This ensures that the second image has a second variation of irradiance across the print area that is much smaller than the first variation, resulting in highly uniform illumination. The grayscale adjustments may be stored for future use.

At step 450, the method 400 includes moving the projector and a print surface of the 3D printer so that a layer of degassed resin is in the print area of the projector. As described in previous implementations, the degassed resin may be formulated with a base monomer, a photoinitiator, a TEMPOL polymerization inhibitor to compensate for the removal of oxygen (i.e., degassing), and a tetraacrylate crosslinker to maintain structural strength. Furthermore, this step can be performed within a depressurized vacuum chamber to maintain a vacuum environment around the degassed resin, preventing the return of dissolved gases.

At step 460, the method 400 includes projecting the second image into the print area using the projector to polymerize the layer of the degassed resin according to the second image. By utilizing the uniformly corrected second image in combination with the bubble-free degassed resin chemistry, consistent and structurally sound interconnected negative features can be successfully printed anywhere within the bounds of the print area.

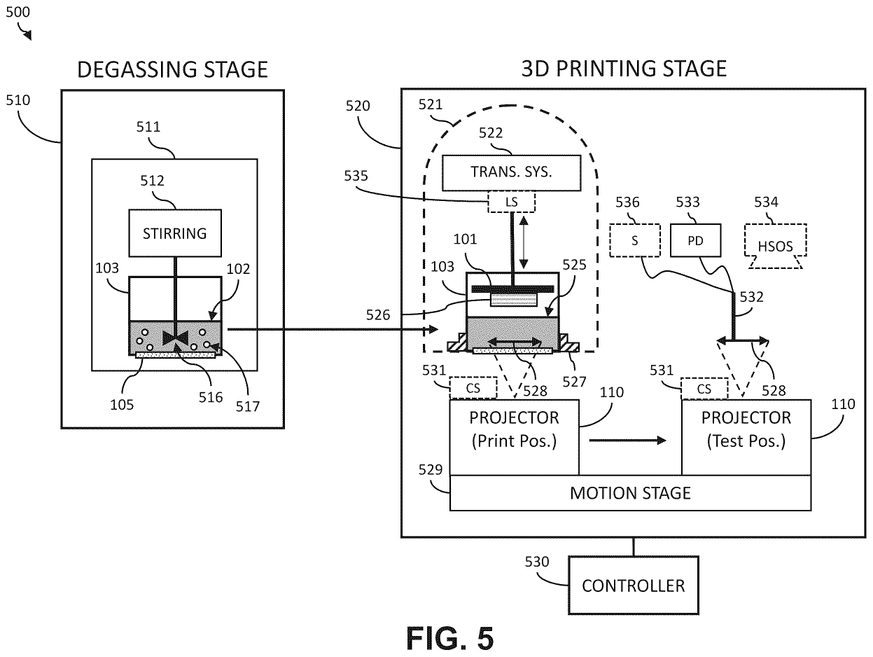

FIG. 5 is a schematic block diagram of a system for 3D printing a microfluidic device according to a possible implementation of the present disclosure. The system 500 includes a degassing stage 510 and a 3D printing stage (i.e., 3D printer 520). The degassing stage 510 includes a first vacuum chamber 511 configured to receive a resin tray 103 containing a resin 102. As previously described, the resin 102 can include a specialized chemistry to balance flexibility, structural strength, and high-resolution capabilities. In a possible implementation, the resin 102 includes a poly(ethylene-glycol) diacrylate (PEGDA) monomer, a photoinitiator, a TEMPOL polymerization inhibitor, and a Di(trimethylolpropane) tetraacrylate (DTMPTA) crosslinker. In some cases, material properties may be optimal when the TEMPOL polymerization inhibitor is at a concentration of approximately 210 ppm, and the DTMPTA crosslinker replaces approximately 10% of the PEGDA monomer concentration. Within the first vacuum chamber 511, a ring stir bar 516 is suspended within the resin 102 above a bottom of the resin tray 103. Suspending the ring stir bar 516 prevents contact with and potential damage to a polymer (e.g., FEP) film print surface covering a bottom, inner surface of the resin tray 103. A stirring mechanism 512 rotates the ring stir bar 516 to agitate the fluid and help remove dissolved gases (e.g., bubbles 517) from the resin 102 as the first vacuum chamber 511 is depressurized.

The resin is typically kept at the degassing stage for about 30 minutes to an hour. The exact duration depends on the pressure, as the degassing process continues until the vacuum chamber reaches a stable pressure of approximately 20 to 35 mTorr. Using a magnetic stirrer to agitate the liquid resin during this stage can reduce the degassing time from several days down to just an hour or less. Additionally, if the resin is used for multiple consecutive prints at atmospheric pressure and begins to absorb air again, it can be placed back into the degassing chamber for about 30 minutes of re-degassing. The result of the degassing stage 510 is a degassed resin 525.

After the resin is degassed, the resin tray 103 is transferred to the 3D printing stage (i.e., 3D printer 520). The 3D printer 520 can be equipped with a second vacuum chamber 521. The second vacuum chamber 521, which may take the form of a glass bell jar, includes a receptacle 527 configured to receive the resin tray 103 containing the degassed resin 525. The second vacuum chamber 521 can be depressurized to maintain a vacuum environment that prevents a return of the dissolved atmospheric gases during a printing process. The 3D printer 520 also includes a build platform that provides a print surface 101 for layers 526 of the microfluidic device during 3D printing. The build platform is coupled to a translation system 522 configured to move the build platform in and out of the resin tray 103. To monitor the mechanical forces exerted on the printed structures during the cyclic layer separation steps, a load cell 535 supports the build platform and is configured to measure in situ forces. Below the resin tray 103, the system 500 includes a projection system (i.e., projector 110) configured to project images into a print area 528. The projector 110 includes a light source 114, such as a 365 nm or 385 nm LED, and a digital micro-mirror device 113. The digital micro-mirror device provides spatial light modulation to generate the projected images. For example, the digital micro-mirror device may utilize a pulse-width modulated (PWM), 8-bit grayscale setup with 256 time segments per frame to provide precise optical dose control via grayscale images. In other words, PWM signals are applied to mirrors (i.e., pixels) in the DMD to generate bit planes, which form grayscale images. The DMD's PWM period is approximately 5 milliseconds, which is roughly 100 times faster than the standard layer exposure time. This rapid switching frequency ensures that the use of grayscale images does not introduce unintended artifacts during the printing process. To accurately monitor these rapid changes caused by the PWM signals, the system incorporates a high-speed optical sensor 534, such as a 100 kHz photodiode, to measure the PWM timings.

To eliminate printing artifacts caused by non-uniform illumination, the system 500 incorporates a suite of diagnostic testing sensors and a motion stage 529. The motion stage 529 is configured to move the projector 110 from a print position beneath the resin tray 103 to a test position beneath the suite of diagnostic testing sensors. In the test position, the projector 110 and the print area 528 can be scanned by an optical fiber 532. In particular, after moving the projector to the test position, the projector 110 may be moved relative to the test position to scan its projected image over a (stationary) optical fiber 532.

The optical fiber 532 is coupled to an optical detector 533 configured to measure irradiance at a point. In a possible implementation, the optical fiber 532 can be a bare fiber with a 50 micrometer diameter core, which defines the spatial sampling resolution. The optical fiber 532 is configured to route the captured light to the optical detector 533, which can be implemented as an optical photodiode configured to generate spatial samples of the irradiance. In some embodiments, the optical fiber 532 splits the routed light, directing a portion to the photodiode to measure optical power and another portion to a spectrometer 536 to measure the actual emission spectrum of the light source 114. The spectrometer 536 allows the system to monitor for long-term wavelength drift as the light source 114 ages. As mentioned, the system 500 may further include a high-speed optical sensor 534, such as a 100 kHz photodiode with a 3 millimeter diameter area, to accurately measure the pulse-width modulation timings of the digital micro-mirror device 113 to verify that the PWM switching frequency is sufficiently fast to avoid artifacts when projecting grayscale images. For example, a PWM switching period may be at least 100 times faster than a standard layer exposure time (e.g., 400 to 450 milliseconds for a 2% NPS resin formulation).

A goal of the system 500 is to ensure the high-yield (e.g., defect-free) fabrication of intricate negative features across the entire print area 528. To achieve this, a controller 530 manages the hardware interactions in a test of the uniformity of the projector. For the test, the controller 530 is configured to project a uniform image and control the motion stage 529 to scan the projector's image across the optical fiber 532 so that the optical detector 533 receives spatial samples of the image projected by the projector 110. While the projected image may have uniform grayscale values for its pixels, the projection may be non-uniform. The controller 530 analyzes these spatial samples to map the illumination profile and determine necessary grayscale adjustments. In a possible implementation, the controller 530 may be configured to create (and store) an inverted grayscale map based on the test. This inverted grayscale map (i.e., calibration) may then be recalled and applied to subsequent images (e.g., layer images) transmitted to the projector 110. The inverted grayscale map may achieve uniformity by digitally dimming the brightest regions, which reduces the overall optical energy delivered to the degassed resin 525. As a result, the controller 530 may be further configured to increase the power of the light source 114 when projecting the subsequent images to compensate for the reduced brightness caused by the grayscale adjustments.

To increase (e.g., maximize) image resolution, the system 500 may further include a confocal distance sensor 531 configured to precisely measure a distance from the optics of the projector 110 to the print area 528 (i.e., focal plane). The controller 530 can use this measurement to actively correct the focus of the projected images, keeping the print area 528 within approximately 10 micrometers of ideal focus.

While printing inside a depressurized vacuum chamber (i.e., second vacuum chamber 521) effectively eliminates large gas bubbles, the vacuum environment actually lowers the nucleation threshold for any remaining dissolved gases in the resin. Because of this lowered threshold, the cyclic mechanical forces during layer separation and peel-off can still cause residual microbubbles to form. In extremely high-density architectures, such as an 11,200-valve array, these residual microbubbles can cause membrane defects and device failures.

Accordingly, for some microfluidic devices, printing the degassed resin at a higher (e.g., atmospheric) pressure may actually help to suppress residual microbubble formation by effectively raising the nucleation threshold to keep any remaining dissolved gas safely in solution. Although the degassed resin may be exposed to the air during this process, it can remain bubble-free for a window of time (i.e., time period). Accordingly, the printing may be constrained by this time period (i.e., period) and may include one or more subsequent degassing steps. In some implementations, this time period is long enough to complete one or two consecutive prints (e.g., 2 hours) before absorbing enough atmospheric gas to require re-degassing at the degassing stage 510.

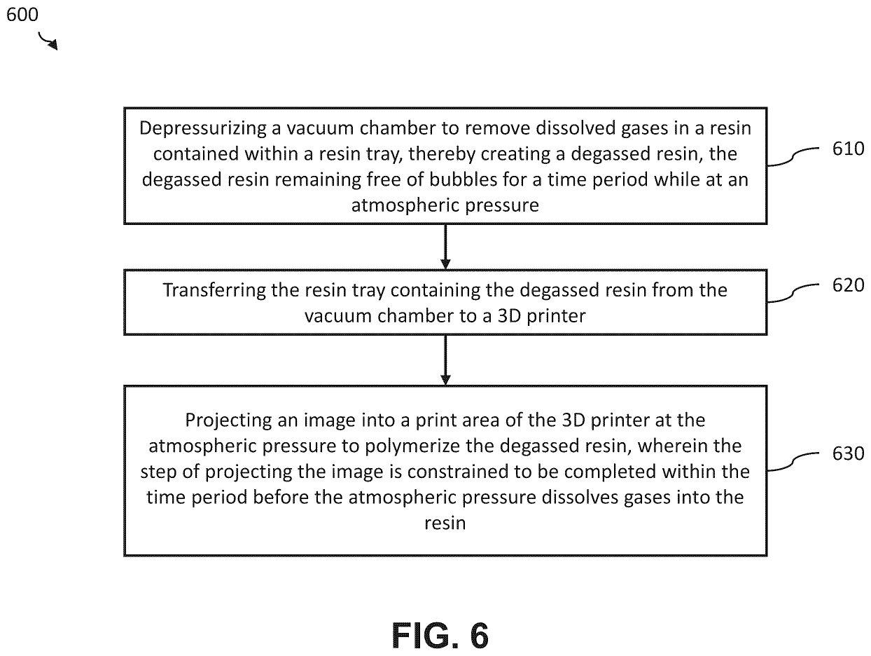

FIG. 6 is a flowchart for a method for 3D printing a microfluidic device according to a third possible implementation of the present disclosure. At step 610, the method 600 includes depressurizing a vacuum chamber to remove dissolved gases in a resin contained within a resin tray, thereby creating a degassed resin. The degassed resin remains free of bubbles for a time period while at atmospheric pressure. In the context of the 3D printing methods, atmospheric pressure is contrasted with vacuum environments, which are achieved by depressurizing a chamber to levels such as 20 to 100 mTorr for degassing, or 200 mTorr to 1 Torr for printing. In general, scientific terms, atmospheric pressure may be in a range between 730 Torr and 780 Torr.

At step 620, the method 600 includes transferring the resin tray containing the degassed resin from the vacuum chamber to a 3D printer.

At step 630, the method 600 includes projecting an image into a print area of the 3D printer at the atmospheric pressure to polymerize the degassed resin, wherein the step of projecting the image is constrained to be completed within the time period before the atmospheric pressure dissolves gases into the resin. Printing under atmospheric pressure with the degassed resin substantially suppresses residual bubble formation, enabling the fabrication of fully intact devices.

When performing multiple consecutive prints, the method 600 includes switching a glass slide adhered to the bottom of a build platform of the 3D printer between each consecutive print, which may help to speed up the process of moving between prints. Further, the printing environment can be adjusted based on the time period. For example, the multiple consecutive prints can be completed at atmospheric pressure if a total print time remains within the time period. Alternatively, the print area can be enclosed within a bell jar and depressurized to maintain a vacuum environment around the print area to prevent the time period from expiring during the multiple consecutive prints. If the total print time exceeds the time period and the printing environment is at atmospheric pressure, the method further includes pausing the 3D printer, returning the resin tray to the vacuum chamber, and re-degassing the resin to re-establish the time period.

The resin utilized in this method 600 may include a diacrylate monomer, a photoinitiator, a tetraacrylate crosslinker including between approximately 1 percent and 10 percent of a monomer concentration, and a TEMPOL polymerization inhibitor at a concentration of approximately 200 ppm. This formulation can compensate for the lack of dissolved oxygen while maintaining structural strength and flexibility.

To ensure high-resolution printing across the entire area, the step 630 of projecting the image into the print area includes adjusting grayscale values of the image. This is achieved by setting an irradiance threshold of approximately 70 percent (70%) of a maximum measured irradiance value, assigning the irradiance threshold to any area measured below the irradiance threshold, creating an inverted map of a measured irradiance, and multiplying the image by the inverted map to dim bright areas. Furthermore, the method 600 includes measuring a distance from the optics of the 3D printer to a projection plane using a confocal distance sensor and actively correcting a focus of the image based on the measured distance. During the step of projecting the image, in situ forces are measured using a load cell supporting the build platform disposed within the print area.

Finally, the method 600 includes forming the microfluidic device from a plurality of polymerized layers of the degassed resin. Forming the microfluidic device includes applying pressurized air to force unpolymerized liquid resin out of unexposed regions defining negative features, flushing the unexposed regions defining negative features with isopropyl alcohol, and post-curing the microfluidic device with a 435 nm LED curing station.

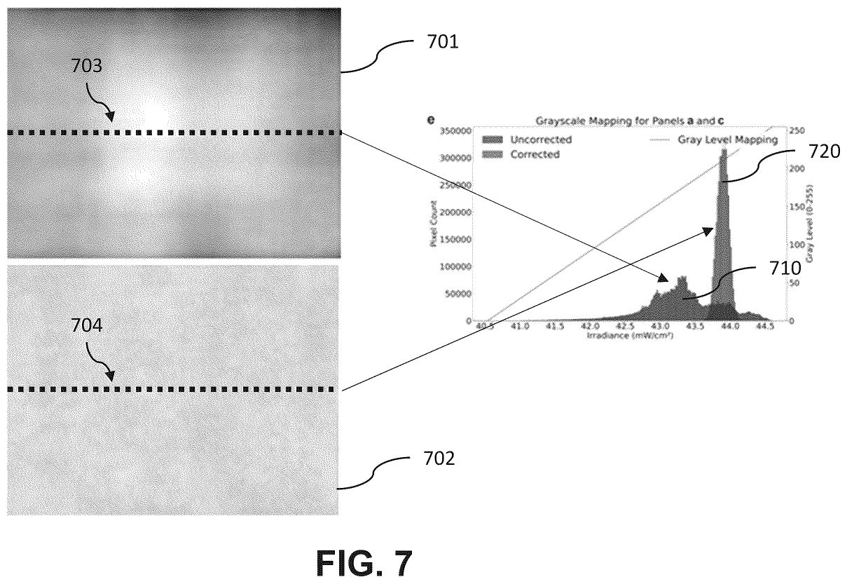

FIG. 7 visually illustrates a grayscale adjustment according to a possible implementation of the present disclosure. To eliminate printing artifacts caused by non-uniform illumination, a first set of irradiances is measured at spatially distinct points across a print area using an optical detector while a first image is projected. This first set of spatial samples 703 corresponds to a first image 701 projected into the print area by a projector of a 3D printer. Analyzing the first set of spatial samples can reveal a first histogram 710 of irradiances. The first histogram has a wide variation in irradiance values. This can be seen in the first image 701 as having a substantially brighter center region compared to the edges of the print area. This non-uniform illumination does not ensure uniform polymerization and can lead to defects in the final device. Accordingly, the grayscale values of the first image 701 are adjusted based on the first variation (i.e., the first histogram 710) to generate a second image 702. The second image 702 is a corrected version of the first image with adjusted grayscale values. In a possible implementation, the second image is created by multiplying the first image 701 by an inverted map of grayscale values to digitally dim the brighter areas. A second set of spatial samples 704 may be measured for the second image 702 and analyzed to produce a second histogram 720. The second histogram 720 has a much smaller variation of irradiance. As can be observed, the second image is much more uniform than the first image. By significantly reducing the irradiance range and standard deviation, the (corrected) second image 702 provides a highly uniform exposure field across the entire print area.

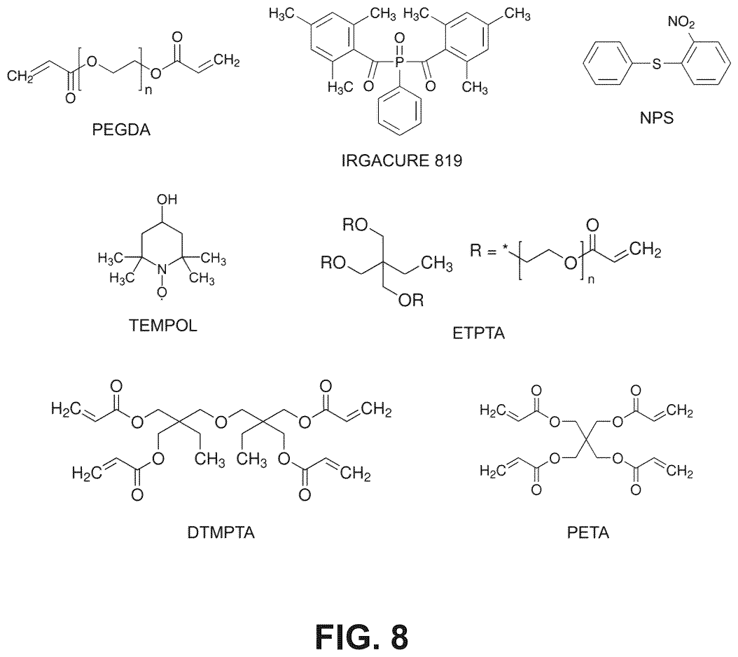

FIG. 8 illustrates the chemical diagrams of resin components according to a possible implementation of the present disclosure. The resin formulation utilizes poly(ethylene glycol) diacrylate (i.e., PEGDA) as the base monomer. To initiate the photopolymerization process, the resin includes a photoinitiator, specifically phenylbis(2,4,6-trimethylbenzoyl)phosphine oxide, which is commonly referred to as Irgacure 819 (i.e., IRGACURE 819). The formulation may also include an ultraviolet (UV) absorber, such as 2-nitrophenyl phenyl sulfide (i.e., NPS).

Because the degassing process removes dissolved oxygen that naturally acts as a polymerization inhibitor by scavenging free radicals, the resin may need a compensatory chemical inhibitor to prevent unwanted polymerization from scattered light. Accordingly, the resin includes 4-Hydroxy-TEMPO (i.e., TEMPOL) to serve as this polymerization inhibitor. While the TEMPOL inhibitor replaces the function of the lost oxygen and restores print fidelity, it also reduces the cross-linking density of the polymer matrix, which can compromise the structural integrity of the material and lead to pitting.

To restore material strength and increase the interconnectedness of the polymer matrix, a crosslinker is added to the resin. FIG. 8 illustrates three potential crosslinker additives: ethoxylated trimethylolpropane triacrylate (i.e., ETPTA), pentaerythritol tetraacrylate (i.e., PETA), and di(trimethylolpropane) tetraacrylate (i.e., DTMPTA). ETPTA is a triacrylate that provides three acrylate groups per molecule. Both PETA and DTMPTA are tetraacrylate crosslinkers that provide four acrylate binding sites per molecule. DTMPTA is typically selected as the preferred crosslinker because it provides the four reaction sites necessary to restore structural stability without the significant viscosity penalty associated with PETA, thereby ensuring that unpolymerized liquid resin can still be easily flushed from the intricate negative features of the microfluidic device.

The disclosed systems and methods improve the scalability and density of 3D printed microfluidic devices by integrating targeted processing strategies, which include vacuum-assisted printing, grayscale correction, and a compensatory resin chemistry. By using these strategies, the disclosed systems and methods can achieve the high-yield fabrication of high-resolution negative features, such as channels, pores, and chambers, across the full build area of a DLP 3D printer by eliminating several critical printing defects that traditionally limit microfluidic fabrication, which are listed below.

First, the disclosed techniques can eliminate bubble entrapment, which otherwise tend to accumulate in the center of the print area or adhere to high-density features, where they obstruct channel formation, create unintended fluid pathways, and bridge delicate structures.

Second, the disclosed techniques can eliminate non-uniform illumination, which can change polymerization across the print area, thereby severely constraining design flexibility and limiting where high-resolution features can be successfully placed.

Third, the disclosed techniques can eliminate over-polymerization and clogging in negative features. Because dissolved oxygen naturally acts as a polymerization inhibitor by scavenging free radicals, its removal during the degassing process leaves the resin highly sensitive to stray light. This causes unwanted over-polymerization that can clog the intended void regions. This defect is eliminated by adding a chemical polymerization inhibitor, such as TEMPOL, to the resin formulation to replace the inhibiting function of the lost oxygen.

Fourth, the disclosed techniques can eliminate material pitting and chalkiness. The addition of the chemical polymerization inhibitor creates a secondary defect by reducing the cross-linking density of the polymer, which results in a chalky material that can suffer from catastrophic pitting and structural failure during the printing process. This weakness can be reduced or eliminated by adding a tetraacrylate crosslinker, such as DTMPTA, which provides four reaction sites per molecule to restore the cross-linking density, structural strength, and overall integrity of the polymerized material.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

Some aspects of the method steps described as being performed by the controller can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected, or coupled to the other element, or one or more intervening elements may be present. In contrast, when an element is referred to as being directly on, directly connected to, or directly coupled to another element, there are no intervening elements present. Although the terms directly on, directly connected to, or directly coupled to, may not be used throughout the detailed description, elements that are shown as being directly on, directly connected, or directly coupled can be referred to as such. The claims of the application may be amended to recite example relationships described in the specification or shown in the figures.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be understood that, in the foregoing description, when an element is referred to as being on, connected to, electrically connected to, coupled to, or electrically coupled to another element, it may be directly on, connected, or coupled to the other element, or one or more intervening elements may be present. In contrast, when an element is referred to as being directly on, directly connected to, or directly coupled to another element, there are no intervening elements present. Although the terms directly on, directly connected to, or directly coupled to may not be used throughout the detailed description, elements that are shown as being directly on, directly connected, or directly coupled can be referred to as such. The claims of the application, if any, may be amended to recite exemplary relationships described in the specification or shown in the figures.

1. A method for 3D printing, the method comprising:
stirring a resin contained within a resin tray within a first vacuum chamber;
depressurizing the first vacuum chamber to remove dissolved gases in the resin, thereby creating a degassed resin;
transferring the resin tray containing the degassed resin from the first vacuum chamber to a second vacuum chamber of a 3D printer;
depressurizing the second vacuum chamber to maintain a vacuum environment around the resin;
moving a projector of the 3D printer and a print surface of the 3D printer so that a layer of the degassed resin is in a print area of the projector; and
projecting an image into the print area using the projector to polymerize the layer of the degassed resin according to the image.

2. The method according to claim 1, further comprising:
repeatedly moving the print surface and projecting images to sequentially polymerize multiple layers of the degassed resin to form a microfluidic device.

3. The method according to claim 1, further including:
flushing unpolymerized degassed resin from regions in the resin corresponding to dark regions of the projected image.

4. The method according to claim 1, wherein the image is a second image, and wherein prior to projecting the second image to polymerize the layer, the method includes:
projecting a first image into the print area using the projector;
moving the projector to measure a first set of irradiances at spatially distinct points using an optical detector positioned in the print area;
analyzing the first set of irradiances to determine a first variation of irradiance across the print area corresponding to the first image; and
adjusting grayscale values of the first image based on the first variation to generate the second image, the second image being a version of the first image with adjusted grayscale values.

5. The method according to claim 4, wherein:
the second image has a second variation of irradiance across the print area corresponding to the second image, the second variation smaller than the first variation.

6. The method according to claim 1, wherein stirring the resin includes:
stirring the resin with a ring stir bar suspended within the resin above a bottom of the resin tray to prevent damage to a film covering a bottom surface of the resin tray.

7. The method according to claim 1, wherein degassing the resin within the first vacuum chamber includes:
depressurizing the first vacuum chamber to approximately 35 mTorr.

8. The method according to claim 1, wherein depressurizing the second vacuum chamber includes:
maintaining the vacuum environment at approximately 200 mTorr.

9. The method according to claim 1, wherein the resin includes:
a poly(ethylene-glycol) diacrylate (PEGDA) monomer,
a photoinitiator,
a polymerization inhibitor to compensate for an inhibiting function being reduced in the resin by the step of depressurizing, and
a tetraacrylate crosslinker.

10. The method according to claim 9, wherein the polymerization inhibitor is:
4-Hydroxy-TEMPO (TEMPOL) at a concentration of approximately 210 ppm.

11. The method according to claim 9, wherein the tetraacrylate crosslinker is:
Di(trimethylolpropane) tetraacrylate (DTMPTA) replacing approximately 10% of the PEGDA monomer.

12. A method for 3D printing, the method comprising:
projecting a first image into a print area using a projector of a 3D printer;
moving the projector to measure a first set of irradiances at spatially distinct points using an optical detector positioned in the print area of the projector;
analyzing the first set of irradiances to determine a first variation of irradiance across the print area corresponding to the first image;
adjusting grayscale values of the first image based on the first variation to generate a second image, the second image being a version of the first image with adjusted grayscale values;
moving the projector and a print surface of the 3D printer so that a layer of degassed resin is in the print area of the projector; and
projecting the second image into the print area using the projector to polymerize the layer of the degassed resin according to the second image.

13. The method according to claim 12, wherein:
the second image has a second variation of irradiance across the print area corresponding to the second image, the second variation smaller than the first variation.

14. The method according to claim 12, further comprising, prior to projecting the first image into the print area:
stirring a resin contained within a resin tray within a first vacuum chamber;
depressurizing the first vacuum chamber to remove dissolved gases in the resin, thereby creating the degassed resin;
transferring the resin tray containing the degassed resin from the first vacuum chamber to a second vacuum chamber of the 3D printer; and
depressurizing the second vacuum chamber to maintain a vacuum environment around the degassed resin.

15. The method according to claim 14, wherein stirring the resin includes:
stirring the resin with a ring stir bar to prevent damage to a film covering a bottom surface of the resin tray.

16. The method according to claim 14, wherein degassing the resin and depressurizing the second vacuum chamber includes:
depressurizing the first vacuum chamber to approximately 35 mTorr and maintaining the vacuum environment in the second vacuum chamber at approximately 200 mTorr.

17. The method according to claim 14, wherein the resin includes:
a poly(ethylene-glycol) diacrylate (PEGDA) monomer,
a photoinitiator,
a TEMPOL polymerization inhibitor, and
a Di(trimethylolpropane) tetraacrylate (DTMPTA) crosslinker.

18. The method according to claim 17, wherein the TEMPOL polymerization inhibitor is at a concentration of approximately 210 ppm and the DTMPTA crosslinker replaces approximately 10% of the PEGDA monomer.

19. A system for 3D printing, the system comprising:
a degassing stage including:
a first vacuum chamber configured to receive a resin tray containing a resin and to degas the resin to remove dissolved gases in the resin, thereby creating a degassed resin;
a printing stage including:
a second vacuum chamber configured to receive the resin tray containing the degassed resin and to prevent a return of the dissolved gases during a printing process;
a motion stage configured to move a projection system configured to project images; and
an optical detector configured to measure irradiance at a point; and
a controller configured to:
control the motion stage to scan the projection system so that the optical detector receives spatial samples of an image projected by the projection system;
determine grayscale adjustments based on the spatial samples; and
apply the grayscale adjustments to the projection system to remove non-uniformities in subsequent images projected by the projection system.

20. The system according to claim 19, wherein the optical detector includes:
an optical fiber configured to route light to a photodiode to generate the spatial samples.

21. The system according to claim 19, wherein the projection system includes:
a light source; and
a digital micro-mirror device.

22. The system according to claim 21, wherein the controller is further configured to:
increase a power of the light source when projecting the subsequent images to compensate for a reduced brightness caused by the grayscale adjustments.

23. The system according to claim 19, further comprising a confocal distance sensor configured to measure a distance from the projection system to a print area, and the controller is further configured to:
move the projection system based on the distance to focus the images in the print area.

24. The system according to claim 19, wherein the degassing stage includes:
a stir bar suspended within the resin above a bottom of the resin tray to prevent contact with an FEP film print surface covering a bottom, inner surface of the resin tray; and
a stirring mechanism configured to rotate the stir bar to help remove the dissolved gases in the resin.

25. A method for 3D printing, the method comprising:
depressurizing a vacuum chamber to remove dissolved gases in a resin contained within a resin tray, thereby creating a degassed resin, the degassed resin remaining free of bubbles for a time period while at atmospheric pressure;
transferring the resin tray containing the degassed resin from the vacuum chamber to a 3D printer; and
projecting an image into a print area of the 3D printer at the atmospheric pressure to polymerize the degassed resin, wherein the step of projecting the image is constrained to be completed within the time period before the atmospheric pressure dissolves gases into the resin.

26. The method according to claim 25, further comprising performing multiple consecutive prints, wherein performing the multiple consecutive prints includes:
switching a glass slide adhered to a bottom of a build platform of the 3D printer between each consecutive print; and
adjusting a printing environment based on the time period by either:
completing the multiple consecutive prints at atmospheric pressure if a total print time remains within the time period; or
enclosing the print area within a bell jar and depressurizing the bell jar to maintain a vacuum environment around the print area to prevent the time period from expiring during the multiple consecutive prints.

27. The method according to claim 26, wherein if the total print time exceeds the time period and the printing environment is at atmospheric pressure, the method further includes:
pausing the 3D printer;
returning the resin tray to the vacuum chamber; and
re-degassing the resin to re-establish the time period.

28. The method according to claim 25, further comprising forming a microfluidic device from a plurality of polymerized layers of the degassed resin, wherein forming the microfluidic device includes:
applying pressurized air to force unpolymerized liquid resin out of unexposed regions defining negative features;
flushing the unexposed regions defining negative features with isopropyl alcohol; and
post-curing the microfluidic device with a 435 nm LED curing station.

29. The method according to claim 25, wherein projecting the image into the print area includes adjusting grayscale values of the image by:
setting an irradiance threshold of approximately 70% of a maximum measured irradiance value;
assigning the irradiance threshold to any area measured below the irradiance threshold;
creating an inverted map of a measured irradiance; and
multiplying the image by the inverted map to dim bright areas.

30. The method according to claim 25, wherein the resin includes:
a diacrylate monomer,
a photoinitiator,
a tetraacrylate crosslinker including between approximately 1% and 10% of a monomer concentration, and
a TEMPOL polymerization inhibitor at a concentration of approximately 200 ppm.

31. The method according to claim 25, further comprising:
measuring a distance from optics of the 3D printer to a projection plane using a confocal distance sensor; and
actively correcting a focus of the image based on the measured distance.

32. The method according to claim 25, further comprising:
measuring in situ forces during the step of projecting the image using a load cell supporting a build platform disposed within the print area.
